(19) United States
(12) Patent Application Publication
(10) Pub. No.: US 2006/0036598 A1
(43) Pub. Date: Feb. 16, 2006

(54) Computerized method for ranking linked information items in distributed sources

(76) Inventor: Jie Wu, Chavannes-pres-Renens (CH)

Correspondence Address: BLANK ROME LLP, 600 NEW HAMPSHIRE AVENUE, N.W., WASHINGTON, DC, 20037, US

(21) Appl. No.: 11/199,363

(22) Filed: Aug. 9, 2005

Related U.S. Application Data
(60) Provisional application No. 60/600,056, filed on Aug. 9, 2004.

(51) Int. Cl. G06F 17/30; G06F 7/00; G06F 17/24

(52) U.S. Cl. 707/5; 715/501.1; 707/7

(57) ABSTRACT

A computerized method used by a distributed Web search engine for computing a ranking score associated with an item, such as a Web page, comprising the steps of: (1) generating a grouping of items in the Web according to Web sites, geographic criterion, and/or field, (2) determining links among groups; (3) for at least some groups, computing a group ranking using only inter-group links, (4) within at least several of the groups, computing a local item ranking for at least some items within the group, (5) for at least one item, locally computing a global item ranking by multiplying said group ranking and said local item ranking. Advantage: no need to retrieve a global link matrix. Method can be distributed. Reduction of cost in computation, better impeding of spamming, fresher ranking results.

### REFERENCE DATA

This application claims priority of the provisional application for patent U.S. 60/600,056, the contents whereof are hereby incorporated.

Some aspects of the invention have been previously presented by Jie Wu and Karl Aberer, as reported in the following conference papers:
Karl Aberer, Jie Wu, “A Framework for Decentralized Ranking in Web Information retrieval”, The Fifth Asia Pacific Web Conference (APWeb 2003), Sep. 27-29, 2003, Xi'an China
Jie Wu, Karl Aberer, “Using SiteRank for Decentralized Computation of Web Document Ranking”, (Best Student Paper Award), The Third International Conference on Adaptive Hypermedia and Adaptive Web-Based S (AH 2004), Aug. 23-26, 2004, Eindhoven University of Technology, The Netherlands,
Jie Wu, Karl Aberer, “Using a Layered Markov Model for Distributed Web Ranking Computation”, The 25^{th} International Conference on Distributed Computing Systems (ICDCS 2005), Jun. 6-10, 2005, Columbus, Ohio, USA

### FIELD OF THE INVENTION

The present invention concerns a method for ranking linked information items in distributed sources. In particular, the present invention concerns a decentralized method for ranking information retrieved by Internet search engines.

### DESCRIPTION OF RELATED ART

Ranking of items, such as documents, is required in many services and applications. In particular, search engines use various algorithms to sort search results. Query-based ranking methods typically try to determine the distance between each word in the query and each document in a database.

The scientific publication “A distributed search system based on Markov decision processes”, Yipeng Shen; Dik Lun Lee; Lian Wen Zhang, Editor:Hui L C K; Lee D L, Dept. of Comput. Sci.; Hong Kong Univ. of Sci. & Technol., 5th International Computer Science Conference ICSC'99. Proceedings, (Lecture Notes in Computer Science Vol. 1749), pp. 73-82, Published in Berlin, Germany, 1999, xx+518 pp., by Springer-Verlag, ISBN 3540669035, discusses a distributed search system using Markov decision processes to efficienly locate the most relevant servers, given a query. This is a decentralized query-based ranking method; links between Web items are not considered.

In a similar way, U.S. Pat. Appl. 2003/050924 to Faybishenko et al. describes another query-based ranking method, wherein queries are distributed to various information providers in a distributing search network.

The results provided by query-based ranking methods strongly depend on the formulation of the query, and not on the importance or authority of the documents. For this reason, search results often contain lot of unimportant documents, such as commercial advertisings, and eliminate authoritative documents slightly more distant from the query.

By contrast, link-based ranking methods are based on link analysis for assigning authoritative weights to Web pages. U.S. Pat. No. 6,285,999 to Page describes a method used, among others, by the Google search engine under the name PageRank. In the PageRank method, a weight assigned to each document, such as a web page, depends on the number and quality of the links to that document. Intuitively, this means that the rank of a document depends on the probability that a browser through the Web will randomly jump to the document. The method is based on the implicit assumption that the existence of a link from a Web document to another document expresses that the referenced document bears some importance to the content of the referencing document and that frequently referenced documents are of a more general importance.

A similar method has been proposed in the article “Authoritative sources in a hyperlinked environment”, Jon Kleinberg, Proceedings of the ACM-SIAM Symposium on Discrete Algorithms, 1998. A solid theoretical model is however lacking in this method; the algorithm often leads to non-unique or non-intuitive rankings where zero weigths may inappropriately be assigned to parts of a network.

Both algorithms requires a centralized computation of the ranking if used to rank the complete Webgraph (i.e. the graph of hyperlinks between all documents in the World Wide Web) However, doing a computation of the weight of each item in the Webgraph is extremely time-consuming. According to recent research result, the Web consists of approximately 2.5 billion documents in 2000, with a rate of growth of 7.3 million pages per day. This web growth rate continuously imposes high pressure on existing search engines. Repetitive computation is required even if only a small part of the global web is changed. The reason is that a global link adjacency matrix is required to compute the final ranking of items.

The computation of a ranking based on the whole Webgraph is also costly. In 2000, a search engine like Google indexes 300 million pages and 2 million terms every month, resulting in about 1 terabyte of data to index. Google already uses a cluster of 15'000 commodity-class PCs running Linux to provide its service (although not all are used for the ranking computation).

State of the Art Webcrawler also suffer from the latency in retrieving a complete Webgraph for the computation of the ranking. Most search engines update on a roughly monthly basis. Since the time needed to retrieve all the existing and newer Web increases, it will also take longer time to integrate it into the database. Thus it takes longer for a page to be exposed on search engines. As a consequence, the Webgraph structure that is obtained will be always incomplete, and the global ranking computation thus less accurate.

Moreover, the rank assigned to a document only depends on links from other documents accessible by the ranking device. Thus links from unknown or inaccessible parts of the Webgraph, such as the hidden Web or documents available on Intranets, are not considered.

Another method for calculating page ranks with a greater computational efficiency has been described in U.S. Pat. Appl. No. 2005/0033742 to Kamvar et al. This method uses the classification of pages in the Web domain names, and the facts that most links in the web are between pages of the same domain. This classification is used to decompose and simplify the computation of ranks into separable steps, thus increasing the speed of link-based ranking. In effect, the predominantly block-diagonal structure of the link matrix, where blocks correspond to internal links within Web sites, means that the blocks may be decoupled from each other and treated independently as localized link matrices. This allows the computation of the ranks to be decomposed into separate parallel computations, one for each block. The result of the separate computations is then centrally composeded (i.e combined) with a block-level ranking to produce an estimated ranking value for each node to be used as the initial value in later centralized iterative ranking computations. A global rank value is computed from the estimated rank value using an iterative link-based ranking technique. A global link matrix of the whole Webgraph is required at least for this last iterative step.

The method thus still requires a central computation from a centrally available matrix. Moreover, the computation is done in a top-down way: the whole link matrix is required at the beginning, but is reduced and decomposed to simplify and possibly distribute the computation. Although this method may reduce the computation cost, it suffers from the same problem for retrieving a complete and up-to-date global link matrix as the method described in U.S. Pat. No. 6,285,999. So logically, the method proposed in this document is still a centralized method of link-based ranking computation.

Another centralized method for producing a different transition matrix before applying the PageRank algorithm is described in U.S. Pat. Appl. No. U.S. 2004/111412. The method is not purely link-based; query-based factors are taken in account when forming the linearly combined matrix. A new computation must then be made for each query.

European patent application EP1517250 to Microsoft describes a new way of assigning the transition probability matrix. The method assigns each Web server a guaranteed minimum score, which is divided among all the pages on that Web server. The aim is to try to improve ranking quality; it is a centralized link-based ranking.

Although these link-based ranking techniques are improvements over prior techniques, in the case of an extremely large database, such as the World Wide Web, or when even a small latency is unacceptable, such as for news search engines, the retrieval in a central place of a global matrix of links between linked information items can take considerable time and transmission channel capacity. Central computation from such a huge matrix is costly. Moreover, those methods do not fully take into account the inherently hierarchical structure of the World Wide Web, which definitely influences the pattern of user behaviour.

Accordingly, it would be valuable to provide a new ranking method that solves the above mentioned problems.

Therefore, it is an aim of the present invention to provide a new method for ranking linked information items in distributed sources which requires neither a global link adjacency matrix nor any other form of storage of the structure of the global or whole Webgraph.

Another aim of the present invention is to provide a new method for ranking linked information items in distributed sources whereby spamming of the linked information items is impeded.

Another aim of the present invention is to provide a new method for ranking linked information items in distributed sources which takes into account the hierarchical structure of the collection of items.

Another aim of the present invention is to provide a new method for ranking linked information items where non-iterative algebraic operations are used to compose rankings with different semantic contexts to generate a global ranking for the items, instead of performing iterative computations at the level of global link adjacency matrix.

### BRIEF SUMMARY OF THE INVENTION

According to the invention, these aims are achieved by means of a method comprising the steps of:
(1) generating a grouping of the items in accordance with a choosen grouping strategy;
(2) using the linking of the items and the grouping of the items for generating link among groups;
(3) generating a group score for each of the linked groups and, within each of the groups, generating an item score for each of the items within the group;
(4) using the group scores and the item scores in generating the ranking.

According to another embodiment, these aims are also achieved by means of a ranking method comprising the steps of:
(1) generating a grouping of the items in accordance with a choosen grouping strategy;
(2) determining links among groups;
(3) for at least some groups, computing a group ranking using only inter-group links,
(4) within at least several of the groups, computing a local item ranking for each items within the group,
(5) for at least some items, computing a global item ranking based on said group ranking and on said local item ranking.

This has the advantage that no centralized computation of a global link matrix is needed. A link-based ranking of each node may be determined without retrieving at a single place the complete link structure of the network.

This also has the advantage that an increased use of local ranking, as compared to global ranking, is made. Computing local rankings not only allows to partition the problem of determining a global ranking and to derive this ranking from fresher information, but also allows to peruse information that is only locally available for the ranking computation. Examples of such information are the hidden Web and usage profiles. Thus even links from document accessible by a ranking device, for example in a company local area network, but not by external users, may be used for modifying the ranking of other documents.

Moreover, different ranking algorithms may be used for computing the local item rankings within different groups. Thus the algorithm used may be well suited to the type and number of items, and to the structure and number of the links within each group.

The method of the invention further has the advantage that it can be executed for example, but not only, by a distributed system, for example by a Peer-2-Peer system. By decentralizing the task of information management at a global scale, and thus avoiding the use of central databases or central control, better scalability to large numbers of users can be achieved. Resources are shared at the level of both computing and knowledge.

Some of the potential that such an approach bears include a better scalable architectures and improved usage of distributed knowledge. The key in making such an approach work lies in the ability to compose (i.e. combine) global rankings from local rankings.

### BRIEF DESCRIPTION OF THE DRAWINGS

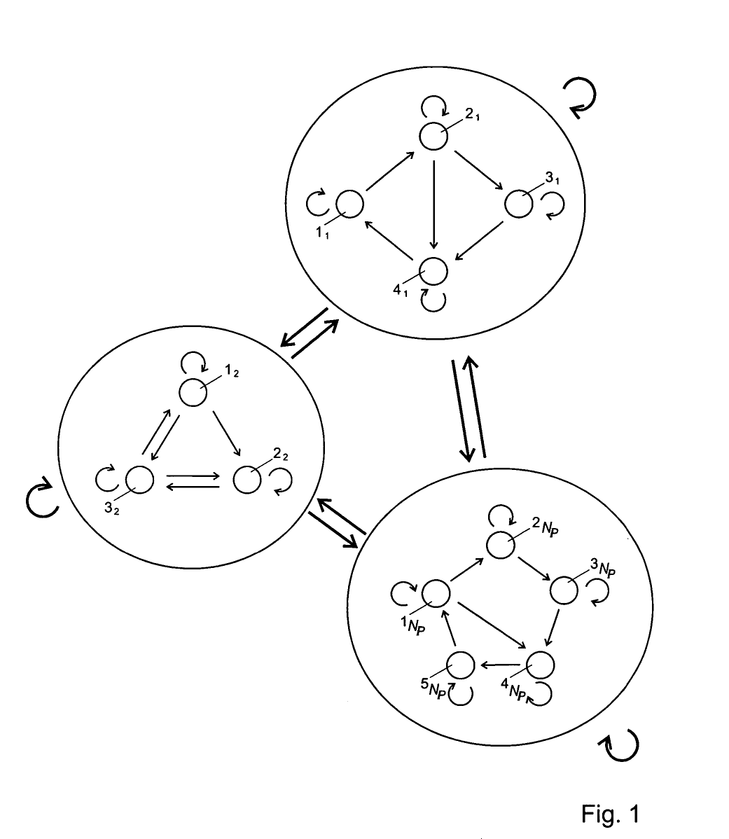

The invention will be better understood by with the aid of the description of an embodiment given by way of example and illustrated by FIG. 1, which shows an example of Layered Markov Model structure as used in one embodiment of the invention.

### DETAILED DESCRIPTION OF POSSIBLE EMBODIMENTS OF THE INVENTION

We will now describe different embodiments of the invention. The description also includes different theoretical models, and proposes one ranking algebra which allows to formally specify different methods of composing rankings, as well as a model of a set of linked items based on layered Markov Models.

In the following of the description, depending on the context, we use the words items, documents, state or pages for designating objects one want to rank. Depending on the context, we use the words groups, sub-sets, phases, domains for designating various sets of objects that may be ranked locally.

The first observation we make is that there exists a certain likelihood that a local link, i.e. a link that references an item, such as a document, within the same local group or domain, typically a Web site, is likely to be semantically more “precise” since the author of the link is likely to be better informed about the semantics and particular importance of the local documents than an external author.

The second observation we make is that documents that are globally considered as important, also locally will have greater importance. This second observation suggests that it might be plausible to identify documents of global importance based on there local rankings only.

The third observation we make is that each Website establishes a specific semantic context. Depending now on the context we might specifically take advantage of the semantics implicit in certain Websites in order to obtain rankings that are tuned towards certain interest profiles. All of these three observations lead us to the conclusion that it might be worthwhile to consider from a semantic perspective instead of a single global ranking various compositions of local rankings for the following three different but not mutually exclusive purposes:
1. Obtaining more precise rankings by exploiting local knowledge;
2. Reconstructing global rankings from local rankings in order to distribute the ranking effort;
3. Using selected local rankings in order to tune the resulting ranking towards specific interest profiles.

Moreover, we performed a number of experiments that indicate that conventional, centralized link-based ranking might have some undesirable properties with respect to stability. We classified the problems into the effect of agglomerate documents on the ranking and the stability of local rankings.

Effects of Agglomerate Documents

Previous studies on the HITS algorithm revealed that the algorithm is prone to the problem of mutual reinforcement: the hub-authority relationships between pages are mutually reinforced because people put some one-to-many or many-to-one links in web sites. This problem can be solved in a heuristic way by dividing the hub or authority weights in the computation by the in-degree or out-degree number.

The same phenomenon also occurs for the PageRank algorithm. The heuristic solution used by HITS to circumvent the problem cannot be applied to PageRank, since the division by the out-degree number is already used in the PageRank algorithm.

Stability of Local Ranking

Computation of global rankings merges information that is drawn both from local links and remote links. An interesting question is on the influence local versus remote links can have on the outcome of the ranking computation.

Experiments has shown that prior art ranking methods relying solely on global rankings could merge the local ranking and the global ranking (assessments by others) in a somewhat arbitrary manner. Therefore a separation of these concerns is a promising approach in order to reveal more precise information from the available link structure.

The Ranking Algebra

We will now introduce an algebraic framework for rankings, a ranking algebra, similarly as it is done for other types of data objects (such as using relational algebra for relations). The ranking algebra will allow to formally specify different methods of composing rankings, in particular, for aggregating global rankings from local rankings originating from different semantic contexts.

Definitions

First we have to define the domain of objects (items) that are to be ranked. Since rankings can occur at different levels of granularity there will not be rankings of documents only, but more generally, rankings over subsets of documents. This leads to the following definition.

Definition 1: A partition of a document set D is a set P of disjoint, non empty subsets of D where P={p₁, . . . , pₖ}, D=Uᵢ₌₁^{k} pᵢ. We denote P (D) or briefly P as the set of all possible partitions over the document set D. We call each of the disjoint subsets a zone. We use P₀ denote the finest partition where each zone in it is a single web document. So rankings at the document levels are also expressed over elements of P which makes our ranking framework uniform independent of the granularity of ranking. We also use Pₛ to denote the partition according to web sites, assuming that there exists a unique way to partition the Web into sites (e.g. via DNS). Then each zone corresponds to the set of web documents belonging to an individual site.

In order to be able to compare and relate rankings at different levels of granularity we introduce now a partial order on partitions.

Definition 2: Given P (D), the relation cover over P (D) for P₁. P₂∈P (D) is denoted as P₁<<P₂ and holds iff. ∀p₁∈P₁, ∃p₂∈P₂.p₁⊂p₂.

We also say that P₁ is covered by P₂ or P₂ covers P₁. The relation P₂>>P₁ is defined analogously.

We will also need a possibility to directly relate the elements of two partitions to each other (and not only the whole partitions as with cover). Therefore we introduce the following operator.

Definition 3: For P₁, P₂∈P, P₁>>P₂ the mapping ρ_{p1>>p2}: P₁→2^{ₛ} is defined for p∈P₁ and q∈P₂ as q∈ρ_{p1>>p2}(p) iff. q⊂p.

This operator selects those elements of the finer partition that are covered by the selected element p of the coarser partition. For example, for Pₛ>>P₀, given a web site S∈Ps, the operator maps it to its set of web documents contained in this site: ρ(S)⊂P₀.

The basis for computing rankings are links among documents or among sets of documents. Therefore we introduce next the notion of link matrix. Link matrices are always defined over partitions, even if we consider document links. Also we define link matrices only for sub-portions of the Web, and therefore introduce them as partial mappings. Note that it makes a difference whether a link between two entities is undefined or non-existent.

Definition 4: Given P∈P a link matrix M_{P}∈M_{P} is partial mapping M_{P}: P×P→{0, 1}. In particular if M_{P} is defined only for values in P₁⊂P then we write M_{P}(P₁). We say then M_{P}(P₁) is a link matrix over P₁.

A number of operations are required to manipulate link matrices before they are used for ranking computations. We introduce here only those mappings that we have identified as being relevant for our purposes. The list of operations can be clearly extended by other graph manipulation operators.

The most important operation is the projection of a link matrix to a subset of the zones that are to be ranked.

Definition 5: For P∈P (D), P₁⊂P and M_{P}∈M_{P}, the node projection π_{P}_{₁}: M_{P}→M_{P}(P₁) satisfies π_{P}_{₁}(M_{P})(p, q), p, q∈P defined iff. p, q∈P₁ and M_{P} is defined for p ,q.

We also need the ability to change the granularity at which a link matrix is specified. This is supported by the contraction operator.

Definition 6: For P₁, P₂∈P(D) with P₁>>P₂ and link matrices M_{P}_{₁}∈M_{P}_{₁} and M_{P}_{₂}∈M_{P}_{₂} the contraction Δ^{P}^{₁}^{>>P}^{₂}: M_{P}_{₂}→M_{P}_{₁} is the mapping that maps M_{P}_{₂} to M_{P}_{₁} such that for p′, q′∈P₁, M_{P}_{₁}(p′, q′) defined iff. M_{P}_{₂}(p, q) defined for all p, q∈P₂ with p⊂p′, q⊂q′ and M_{P}_{₁} (p: q′)=1 iff. M_{P}_{₁}(p′, q′) defined and exists p, q∈P₂ with p⊂p′, q⊂q′, M_{P}_{₂}(p, q)=1.
for p, q∈P₂ M_{P}_{₂}(p, q)=1 and defined iff. for p′, q′∈P₁ with p⊂p′, q⊂q′·M_{P}_{₁} (p′, q′)=1 and defined.

In certain cases it is necessary to directly manipulate the link graph in order to change the ranking context. This is supported by a link projection.

Definition 7: For P∈P (D), P₁⊂P and M_{P}∈M_{P} the link projection Λ_{P}_{₁}: M_{P}→M_{P} satisfies for p∈P−P₁. q∈P−P₁ Λ_{P}_{₁}(M_{P})(p, q)=0 iff. M_{P}(p, q) defined and Λ_{P}_{₁} (M_{P})(p, q)=M_{P}(p, q) for all other p, q.

Based on link matrices rankings are computed. The domain of rankings will again be partitions of the document set.

Definition 8: For P∈P (D) a ranking R_{P}∈R_{P} is a partial mapping R_{P}: P→[0; 1]. When the ranking is defined for P₁⊂P only we also denote the ranking as R_{P}(P₁).

Normally rankings will be normalized. This leads to the following definition:

Definition 9: A normalized ranking RP satisfies Σ_{peP}R_{P}(p)=1. Given a general ranking R_{P}∈R_{P} the operator μ: R_{P}→R_{P} derives a normalized ranking by
μ(R_{P}(p)) =R_{P(p)}/Σ_{peP}^{R}⁽⁾.

The connection between rankings and link matrices is established by ranking algorithms. As these algorithms are specific, we do not define their precise workings.

Definition 10: A ranking algorithm is a mapping R^{alg}ₚ:M_{P}(P₁)→R_{P}(P₁)

We will distinguish different ranking algorithms through different superscripts. In particular, we will use R^{PageRank}, the Page rank algorithm, and R^{Count}, the incoming links counting algorithm, in our later examples.

As for link matrices we also need to be able to project rankings to selected subsets of the Web.

Definition 11: For P∈P (D) and R_{P}∈R_{P} the projection π_{P}_{₁}: R_{P}→R_{P}(P₁) is given as π_{P}_{₁}(R_{P})=μ(R′_{P}) iff. R′_{P}(p)=R_{P}(p) with p∈P₁ and R_{P}(p) defined.

In many cases different rankings will be composed in an ad-hoc manner driven by application requirements. We introduce weighted addition for that purpose.

Definition 12: Given rankings R′_{P}∈R_{P}, i=1, . . . n and a weight vector ω∈[0, 1]ⁿ then the weighted addition Σₙ: Rⁿ_{P}×[0, 1]ⁿ→R_{P} is given as Σₙ(R¹_{P}_{₁} . . . , Rⁿ_{P}_{₂}, ω₁, . . . , ωₙ)=μ(R*_{P}) iff. R*_{P}(p)=Σᵢ₌₁ⁿω₁R¹_{P}(p) and R¹_{P}(p) defined for i=1, . . . , n.

We will in particular look into methods for systematic composition of rankings. These are obtained by composing rankings that have been obtained at different levels of granularity. To that end we introduce the following concepts.

Definition 13: A covering vector of rankings for R_{Q} over R_{P} with Q>>P is a partial mapping R^{Q}_{P}∈R^{Q}_{P} with signature R^{Q}_{P}: Q→R_{P}.

This definition says that for each ranking value of a ranking at higher granularity there exists a ranking at the finer granularity. Next we introduce an operation for the systematic composition of rankings using covering vectors.

Definition 14: Given a covering vector R^{Q}_{P} with Q>>P the folding is the mapping F^{Q>>P}: R^{Q}_{P}×R_{Q}→R_{P} such that for R^{Q}_{P}∈R^{Q}_{P}, R_{Q}∈R_{P}, F^{Q>>P} (R^{Q}_{P}, R_{Q})=μ(R*_{P}) iff. for p∈P₁
R*P(p)=Σq∈Qst.R_{P(q)}^{Q} and defined (R_{Q}(q)*R^{Q}^{_{P}}(q)p)).

Computing Rankings from Different Contexts

In this section we give an illustration of how to apply the ranking algebra in order to produce different types of rankings by using different ranking contexts.

Suppose Ps={s₁, . . . , sₖ}⊂Ps is a subset of all Web sites. If we determine Di=ρ(si) we see that Dᵢ⊂P₀ corresponds to the set of documents of the Web site si. We denote with Ds=U^{k}ᵢ₌₁Di the set of all documents occurring in one of the selected Web sites. For ranking documents from the subset Ps of selected Web sites we propose now different schemes.

Global site ranking: The global site ranking is used to rank the selected Web sites using the complete Webgraph. Since only inter-site links are used the number of links considered for computing the ranking is substantially reduced as compared to the global Web graph. In addition such rankings should only be recomputed at irregular intervals. The ranking algorithm to be used may be PageRank. Global site rankings for subsets of Web sites could be provided by specialized ranking providers or Web aggregators. Formally we can specify this ranking as follows. Given the Web link matrix M∈M_{P}_{₀} and a selected subset of Web sites Ps⊂Ps the global site ranking of these Web sites is given as
R_{PG}=π(R^{Pagerank}(Δ^{PG>>PO}((M)))∈R_{Ps}(P_{S})

Local site ranking: In contrast to the global site ranking we use here as context only the subgraph of the Web graph that concerns the selected Web sites. In this case we prefer to use the ranking algorithm R^{Count} since the number of inter Web site links may be more limited for this smaller link graph. Formally we can specify this ranking as follows. Given the Web link matrix M∈M_{P}_{₀} and a selected subset of websites Ps⊂Ps the local site ranking of these websites is
R=R^{Count}(π_{Ps}(Δ^{P}^{ₛ}^{>>P}^{ₛ}(M))∈R_{Ps}(Ps)

Note that we assume that R^{count} ranks only documents for which the link matrix is defined and thus we don't have to project the resulting ranking to the subset of Web sites taken into account.

Other algorithms, including PageRank or even a manual ranking method, may be used for the local site ranking.

Global ranking of documents of a Web site: This ranking is the projection of the global PageRank to the documents from a selected site. Formally we can specify this ranking as follows. Given the Web link matrix M∈M_{P}_{₀} and the Web site Si∈Ps with Di=ρPs>>Po (Si), then the global ranking of documents of a Web site is
R^{global}_{D}_{ᵢ}=π_{Di}(R^{Pagerank}(M))=π_{Di}(R^{global}_{D}_{ᵢ})∈R_{Ps}(Dᵢ)

A more restricted form of global ranking is when we only include the documents from the set Ds=U^{k}ᵢ₌₁Di. This gives
R^{intermediate}_{Di}=π_{Di}(R^{PageRank}(π_{Ds}(M)))∈R^{P0}(Dᵢ)

The global or intermediate ranking of documents of a set D=Di, U U Dᵢₘ of more than one web sites can be obtained similarly by simply replacing Di with D′ in the projection operators.

Local Internal Ranking for Documents: This corresponds to a ranking of the documents by the document owners, taking into account their local link structure only. The algorithm used may PageRank applied to the local link graph. Formally we can specify this ranking as follows. Given the Web link matrix M∈M_{Po} and the Web site si∈Ps with Di=ρPs>>Po (Si), the local internal ranking is
R_{D}=R^{PageRank}(π_{D}(M))∈R_{Po}(Dᵢ)

Note that we assume here that the PageRank algorithm does not rank documents for which the link matrix is undefined, and therefore the resulting ranking is only defined for the local web site documents.

Other algorithms, including PageRank or even a manual ranking method, may be used for the local internal ranking for documents.

Local External Ranking for Documents: This corresponds to a ranking of the documents by others. Here for each document we count the number of incoming links from one of the other Web sites from the set Ps. The local links are ignored. This results in one ranking per other Web site for each Web site. Formally we can specify this ranking as follows. Given the Web link matrix M∈M_{Po} the Web site sᵢ∈Ps with Dⱼ=ρPs>>Po (sⱼ) to be ranked and the external Web site sⱼ∈Ps with Dⱼ=ρPs>>Po (sⱼ) used as ranking context. We include the case where i=j. Then
R^{LE}_{D}=π_{D}(R^{Count}(Λ_{Dj}(π_{DiUDj}(M))))∈R(Di)

Here also, other algorithms may be used for the local external ranking for documents.

Ranking Aggregation

We illustrate here by using ranking algebra how the rankings described above can be composed to produce further aggregate rankings. Thus we address several issues discussed in previous sections and demonstrate two points:

1. We show that global document rankings can be determined in a distributed fashion, and thus better scalability can be achieved. Hence ranking documents based on global information not necessarily implies a centralized architecture.

2. We show how local rankings from different sources can be integrated, such that rankings can be made precise and can take advantage of globally unavailable information (e.g. the hidden web) or different ranking contents. Thus a richer set of possible rankings can be made available.

Our goal is to produce a composite ranking for the documents in one of the selected subset of Web sites in Ps from the different rankings that have been described before. The specific way of composition has been chosen with two issues in mind: first, we want to illustrate different possibilities of computing aggregate rankings using the ranking algebra, and second, the resulting composite ranking should exhibit a good ranking quality, which we will evaluate in the experimental section, by comparing to various rankings described above.

The aggregate ranking for a Web site si∈Ps with Di=ρ(si) is obtained in 3 major steps. First we aggregate the local external rankings by weighting them using the global site ranking. Since for each Di we can compute a local external ranking Rrelative to Di we can obtain a covering vector RLE(Di) over Ps by defining RLE(Di)(sj)=R. Using the global site ranking we compose an aggregate local document ranking by using a folding operation
R=F(RLE(Di)R)

Then we compose this ranking of documents in Di with the local internal ranking in an ad-hoc fashion, using w_{E} and w_{I} as the weights that we give to the external and internal rankings.
R=Σ₂(R^{LE},R,w_{E},w_{I})

In this manner we have now obtained a local ranking for each Di. We can again use these local rankings to construct a covering vector RCLover Ps by
RCL=R
Using this covering vector we can obtain a global ranking by applying a folding operation. This time we use the local site ranking to perform the ranking
R^{comp}_{D}=F(RCL, R)

Finally we project the ranking obtained to a Web site
R^{comp}_{D}=π_{Di}(R^{comp}_{D})

This composite ranking we will compare experimentally with some of the basic rankings introduced earlier.

We will now give an illustration of how to apply the ranking algebra in a concrete problem setting. The aggregation approach described above has been tested within the EPFL domain which contains about 600 independent Web sites (Ps) identified by their hostnames or IP addresses. We crawled about 2,700,000 documents found in this domain. Using this document collection we performed the evaluations using the following approach: we chose two selected Web sites s₁ and s₂, with substantially different characteristics, in particular of substantially different sizes. For those domains we computed the local internal and external rankings. We also put the EPFL portal web server sₕ (hostname www.epfl.ch) in the collection, since this is a point where most of the other subdomains are connected to. We consider this subset of documents an excellent knowledge source for information of web site importance. So we have PS={s₁, s₂, sₕ} here. We denote the corresponding document ses D₁, D₂, Dₕ.

Then we applied the algebraic aggregation of the rankings obtained in that way, in order to generate a global ranking for the joint domains s₁ and s₂. For local aggregation we chose the values (W_{E},w_{I})=(0.8, 0.2). This reflects a higher valuation of external links than internal links. One motivation for this choice is the relatively low number of links across subdomains as compared to the number of links within the same subdomain. Other weights, including same weights for internal links than for external links, may be used. The resulting aggregate ranking R^{comp}_{DD} for the joint domains s₁ and s₂ is then compared to the ranking obtained by extracting from the global ranking R^{global}_{D}_{₁}_{UD}_{₂} computed for the complete EPFL domain (all 2,700,000 documents) for the joint domains s₁ and s₂. The comparison is performed both qualitatively and quantitatively.

We can observe substantial differences between the global page ranking used in the prior art and the composite ranking method of the invention. In the global page ranking, some obviously important pages are ranked much lower than some less important, but highly mutually interconnected pages. We can assume that this is an effect due to the agglomerate structure of these document collections. These play obviously a much less important role in the composite ranking method of the invention due to the way of how the ranking is composed from local rankings. It shows that the global page ranking is not necessarily the best possible ranking method.

Furthermore, a proper use of the weighting schemes for balancing between the influence of external versus internal links, can be used to amplify important local information in an adaptive manner.

From the comparison and analysis we made, we find that with the ranking method of the invention, the ranking result has been improved in two important aspects: firstly, default important pages (for example the department home) are levered to the rank that they deserve; secondly, the reinforcing effect of some agglomerate pages is defeated to a satisfactory degree. In short, those results making use only of local information approximate the result of PageRank based on global information very well and in some cases appear to be even better with respect to importance of documents.

We want now to describe another embodiment of the ranking method of the invention. This method will be described with theoretical model based on layered Markov Models.

We first define the concept of ordered set as they will be used in later defintions.

DEFINITION 1. A partially ordered set (poset) is a set X together with a relation ≦ such that for all a, b, c∈X:
a≦a (reflexivity)
a≦b, b≦c [symbol] a≦c (transitivity)
a≦b, b≦a [symbol] a=b (antisymmetry).
   A totally order set (toset) is a post for which also for all a, b∈X:
Either a≦b or b≦a.

DEFINITION 2. A ranking is a totally ordered set W bound to a set of Web objects O such that there exists a mapping rw: O→W. Then O is called a ranked Web object set. The particular element w∈W corresponding to a specific object o∈W is the ranking value of o, namely, rw(o)=w.

A ranking is often L1-normalized such that the sum of all ranking value equals 1 and the result can be interpreted as a probability distribution.

DEFINITION 3. A document ranking is a ranking for Web documents. A site ranking is a ranking for Websites.

The problem of ranking Web documents is to find an algorithm to compute a document ranking for all documents in a given Web graph of pages. Ideally such an algorithm should be supported by an underlying model providing an interpretation of the result and the possibility to derive properties of the resulting rankings.

Given the graph of Web pages G_{D} (V_{D}, E_{D}) with N_{D} pages in total, we use the following notations: d∈V_{D} is a Web page, hd is the number of links originating from page d,

$${α}_{d} = \frac{1}{{h}_{d}}$$

is the probability of a random surfer's following one particular link from page d, pa(d) is the set of parent pages of d, i.e. those pages pointing to d, ch(d) is the set of child pages of d, i.e. those pages pointed to by d.

In the classical PageRank model, a surfer is supposed to perform random walks on the flat graph generated by the Web pages, by either following hyperlinks on Web pages or jumping to a random page if no such link exists. A damping factor is defined to be the probability that a surfer does follow a hyperlink contained in the page where the surfer is currently located in. Suppose the damping factor is f, then the probability that the surfer performs a random jump is 1−f.

The classical PageRank Markov model is based on a square transition probability matrix M={m_{i,j}, i, j∈[1, N_{D}]}:

$${m}_{ij} = \{ \begin{matrix}{α}_{i} \\ 0 \\ \frac{1}{{N}_{D}}\end{matrix} \begin{matrix}{h}_{i} \neq 0 , {d}_{j} ∈ ch ( {d}_{i} ) \\ {h}_{i} \neq 0 , {d}_{j} ∉ ch ( {d}_{i} ) \\ {h}_{i} = 0\end{matrix} \qquad ( 1 )$$

However, this matrix does not ensure the existence of the stationary vector of the Markov chain which characterizes the surfer behaviour, i.e., the PageRank vector. As widely accepted, the unaltered Web creates a reducible Markov chain. Thus, the PageRank algorithm enforces a so-called maximal irreducibility adjustment to make a new irreducible transition matrix:

$$\hat{M} = fM + \frac{1 - f}{{N}_{D}} {ee}^{′} \qquad ( 2 )$$

where e is the column vector of fall 1s and e′ is e's transposed. \hat{M} is the primitive, thus the power method will finally product the stationary PageRank vector. In other informal words, the application of PageRank algorithm over a given square matrix is equivalent to first applying the maximal irreducibility adjustment to the matrix, then applying the power method to the new matrix in order to obtain its principal Eigenvector.

We also use M(G) and \hat{M}(G) to denote the function of generating such matrices for a given graph G. Remember that in the function body of \hat{M}(G), personalization of rankings can be obtained by replacing e with a personalized distribution vector in equation (2)

While PageRank assumes that the Web is a flag graph of documents and the surfers move among them without exploiting the hierarchical structure, we consider the Layered Markov Model as a suitable replacement for the flat Markov chain to analyze the Web link structure for the following reasons:
The logical structure of the Web graph is inherently hierarchical. No matter, whether the Web pages are grouped by Internet domain names, by geographical distribution, or by Web sites, the resulting organization is hierarchical. Such a hierarchical structure does definitely influence the patterns of user behaviour.
Web is shown to be self-similar in the sense that interestingly, part of it demonstrates properties similar to those of the whole Web. Thus instead of obtaining a snapshot of the whole Web graph, introducing substantial latency, and performing costly computations on it, bottom-up approaches, which deal only with part of the Web graph and then integrate the partial results in a decentralized way to obtain in the final result, seem to be a very promising and scalable alternative for approaching such a large-scale problem.

FIG. 1 illustrates an example of Layered Markov Model structure. The model consists of 12 sub-states (small circles) and 3 super-states (big circles), which are referred to as phases. There exists a transition process at the upper layer among phases and there are three independent transition processes happing among the sub-states belonging to the three super-states.

When applying the Web surfer paradigm, a phase could be considered as a surfer's staying within a specific Web site or a particular group of Web pages. The transition among phases corresponds to a surfer's moving from one Web site or group to another. The transition among sub-states corresponds to a surfer's movement within the site or group. Thus a comprehensive transition model should be a function of both the transition among phases and the transition among sub-states. In other words, the global system behaviour emerges from the behaviour of decentralized and cooperative local sub-systems.

We consider a two-layer model in the following to keep explanations simple, but the analysis can be extended to multi-layer models using similar reasoning. We introduced now the notations to describe the two-layer model.
Given the number of phases Nₚ, we use {1, 2, . . . ,Nₚ}to label the individual phases and denote the phase active at time t as a variable Z(t). The set of phases is denoted by P={P₁, P₂, . . . , P_{N}_{_{P}}}.
For each phase P₁ the number of its sub-state is n₁. We use {1, 2, . . . , n₁} to label the individual sub-states and denote the state at time t as a variable z¹(t). The set of sub-states of phase P₁ is denoted by

$${O}^{I} = \{ {O}_{1}^{I} , {O}_{2}^{I} , … , {O}_{{n}_{I}}^{I} \} .$$

The overall set of sets of sub-states is denoted by O={O¹, O², . . . , O^{N}^{_{P}}}.
The transition probability at the phase layer is given by Y={y_{IJ}} where Y_{IJ}=P(Z(t+1)=J|Z(t)=I) and 1≦I, J≦N_{P}. The initial state distribution vector is denoted by ν_{Y}
For each phase I, the transition probability at the sub-state layer is given by

$${U}^{I} = \{ {u}_{ij}^{I} \}$$

where uᵢⱼ^{I}=P(Z(t+1)=I, z^{I}(t+1)=j|Z(t)=I,z^{I}(t)=i) and 1≦i, j≦n₁. In addition, U is defined to be the set of all sub-state transition matrices: U={U¹, U², . . . , U^{N}^{_{P}}}. There exists a one-to-one mapping between P and U, namely each phase P₁ has its substate transition matrix U^{I}, 1≦I≦Nₚ. The set of initial state distribution vector is denoted by

$${V}_{U} = \{ {v}_{U}^{1} , {v}_{U}^{2} , … , {v}_{U}^{{N}_{P}} \} .$$

When context is clear, we also use the index of a phase or a sub-state to designate the phase or subs-state. For example, phase2 for P₂ and its sub-state3 for O₃² in O². An overall system state is denoted by a (phase, substate) pair like (2,3) which means the system is at the sub-state3 of phase2. In addition,

$${N}_{P} = {\sum }_{I = 1}^{{N}_{P}} {n}_{I}$$

n is used to denote the total number of overall system states. An overall system state is also called a global system state in contrast to a local sub-state (i.e. a sub-state local to a phase)

DEFINITION 4. A (two-layer) Layered Markov Model is a 6-tuple LMM=(P, Y, ν_{Y}, O, U, ν_{U}) where each dimension has the meaning explained above.

LMM for Ranking Global Systems States

We want to use the Layered Markov Model to compute a ranking for all global system states, i.e., a stationary (if possible) distribution vector for all global system states. Such a ranking also should be uniquely defined.

We assurme that state transition between two global system states is always abstracted as first an inter-phase transition, and then an intra-phase transition.

As an example, suppose we have a phase transition matrix, and three sub-state transition matrix Y, U¹ of the four-substate phase I, U² of the three-substate phase II, and U³ of the five-substate phase III as follows:

$$\begin{matrix}Y = [ \begin{matrix}.1 & .3 & .6 \\ .2 & .4 & .4 \\ .3 & .5 & .2\end{matrix} ] & {U}^{1} = [ \begin{matrix}.3 & .3 & .2 & .2 \\ .5 & .1 & .1 & .3 \\ .1 & .2 & .6 & .1 \\ .4 & .3 & .1 . & 2\end{matrix} ] \\ {U}^{2} = [ \begin{matrix}.2 & .1 & .7 \\ .1 & .8 & .1 \\ .05 & .05 & .9\end{matrix} ] & {U}^{3} = [ \begin{matrix}.6 & .02 & .2 & .1 & .08 \\ .05 & .2 & .5 & .05 & .2 \\ .4 & .1 & .2 & .1 & .2 \\ .7 & .1 & .05 & .1 & .05 \\ .5 & .2 & .1 & .1 & .1\end{matrix} ]\end{matrix}$$

We want to rank at least some of the 12 global system states according to the general authority implied by the transition link structure.

To do so, we need to obtain a global transition probability matrix for the 12 global system states. For Layered Markov Models with homogenously structures sub-states, i.e. all subgraphs corresponding to phases have the same structure, the global transition matrix can be obtained conveniently as a matrix tensor product. Unfortunately, it's impossible to do so for non-homogenous sub-states as they occur for any practical Web graph. Instead we will derive such a matrix relying our notion If layer-decomposability.

Layer-Decomposability

Informally, the property of layer-decomposability ensures the legitimacy of decomposing the transition between two global system states to the two steps of first inter-phase transition then intra-phase transition.

In order to define the decomposability between layers, we first introduce the concept of gatekeeper sub-state.

DEFINITION 5. A gatekeeper sub-state O_{G}^{I} of a phase P₁ is a virtual sub-state appended to the phase, such that it connectors to every other sub-state and every other sub-state is connected to it.

After the introduction of gatekeeper sub-states for phases, the decomposability of a Layered Markov Model is defined as below.

DEFINITION 6. Layers in a Layered Markov Model are decomposable if the transition probability between two given non-gatekeeper sub-states in their two corresponding phases satisfies:

$$\begin{matrix}P ( Z ( t + 1 ) = J , z ( t + 1 ) = j \vert Z ( t ) = I , z ( t ) = i ) \\ = P ( Z ( t + 1 ) = j \vert Z ( t ) = I ) P ( {z}^{j} ( t + 1 ) \\ = j \vert {z}^{J} ( t ) = {o}_{G}^{J} )\end{matrix} \qquad ( 3 )$$

The definition basically assures in the model that whenever a phase transition takes place, it has to go through the gatekeeper sub-state of the destination phase. The gatekeeper sub-state function as the boundary between inter-phase transition and intra-phase transitions.

Denoting the transition probability in phase P_{J} from the gatekeeper substate O_{G}^{J} to sub-state Oⱼ^{J} by U_{Gj}^{J}, the elements of the resulting global transition matrix W are computed as follows:
w(I,i)(J,j)=Y₁Ju_{Gj}^{J} (4)

We have shown that

LEMMA 1. The resulting transition matrix W satisfies the Markovian property.

Transition Probabilities of Gatekeeper Sub-States

To compute (4), for each phase J, we have to obtain the u_{Gj}^{J} values of all j∈[1,n_{J}]

We already have the Markovian (not necessarily irreducible) transition matrix U^{J}. After adding the new virtual gate-keeper sub-state, we need to make the new (nⱼ+1)×(nⱼ+1) matrix Û^{J} Markovian as well. A possible method of applying such a change is:

$${\hat{U}}^{J} = [ \frac{α {U}^{J}}{{( {v}_{U}^{J} )}^{T}} \vert \frac{( 1 - α ) e}{0} ]$$

where 0<α<1 is an adjustable parameter, e is the column vector of all 1s and ν_{U}^{J} is the initial state distribution vector for all the non-gatekeeper sub-states within P_{J}, as we have described before. The new matrix Û^{J} is not only Markovian but also irreducible and primitive.

This method is actually known as the approach of minimal irreducibility in the context of PageRank computation. In detail, applying the power method on Û^{J} will eventually produce its principal Eigenvector. After that, the last element of the vector, which corresponds to the appended gatekeeper sub-state in our case, is removed and the remaining N_{J} elements are re-normalized to make the sum up to 1. The resulting vector π_{U}^{J} is considered as the stationary distribution over all the non-gatekeeper sub-states within the given phase J. We take the N_{J} elements of the stationary distribution vector π_{U}^{J} as the values of all u_{Gj}^{J}, j∈[1,n_{J}].

Interestingly enough, it is shown that this method is equivalent in theory and in computational efficiency to the method of maximal irreducibility. Thus, given the adjustable factor α we actually take the PageRank values of the local sub-states of P_{J} as their u_{Gj}^{J} values, j∈[1,n_{J}]

To compute a ranking for the system states, we need to ensure the primitivity of the new global transition matrix.

LEMMA 2. If Y is primitive and the PageRank values of the local sub-states of P_{J} are taken as their u_{Gj}^{J} values, j∈[1,n_{J}], the global transition matrix W is also primitive.

PROOF. This is a natural consequence of all the u_{Gj}^{J} values being positive.

Thus W has only one Eigenvalue on its spectral circle. The corresponding Eigenvector could be used to rank the states in the overall system. However, we do not make the assumption in our analysis that both Y and U are primitive, we are only sure that both of the mare Markovian. Even if they are not primitive, we can make the resulting W primitive by adopting the same approach as taken in PageRank, the so-called method of maximal irreducibility, by connecting every pair of nodes via random jumps. Once the primitivity is achieved, we can always compute the ranking of the system states.

We now compute the W for our example given by the four Markovian matrices Y, U¹, U² and U³. First, we compute the PageRank vectors for the three phases (denoted by π_{G}^{J}, j=1, 2, 3 here):

$${π}_{G}^{1} = ( \begin{matrix}0.3054 \\ 0.2312 \\ 0.2582 \\ 0.2052\end{matrix} ) {π}_{G}^{2} = ( \begin{matrix}0.1191 \\ 0.2691 \\ 0.6117\end{matrix} ) {π}_{G}^{3} = ( \begin{matrix}0.4557 \\ 0.1038 \\ 0.2014 \\ 0.1106 \\ 0.1285\end{matrix} )$$

Then we use the equation (4) to obtain the new W:

$$W = [ \begin{matrix}0.0305 & 0.0231 & 0.0258 & 0.0205 & 0.0357 & 0.0807 \\ 0.0305 & 0.0231 & 0.0258 & 0.0205 & 0.0357 & 0.0807 \\ 0.0305 & 0.0231 & 0.0258 & 0.0205 & 0.0357 & 0.0807 \\ 0.0305 & 0.0231 & 0.0258 & 0.0205 & 0.0357 & 0.0807 \\ 0.0611 & 0.0462 & 0.0516 & 0.0410 & 0.0477 & 0.1077 \\ 0.0611 & 0.0462 & 0.0516 & 0.0410 & 0.0477 & 0.1077 \\ 0.0611 & 0.0462 & 0.0516 & 0.0410 & 0.0477 & 0.1077 \\ 0.0916 & 0.0694 & 0.0775 & 0.0616 & 0.0596 & 0.1346 \\ 0.0916 & 0.0694 & 0.0775 & 0.0616 & 0.0596 & 0.1346 \\ 0.0916 & 0.0694 & 0.0775 & 0.0616 & 0.0596 & 0.1346 \\ 0.0916 & 0.0694 & 0.0775 & 0.0616 & 0.0596 & 0.1346 \\ 0.0916 & 0.0694 & 0.0775 & 0.0616 & 0.0596 & 0.1346\end{matrix} \\ \begin{matrix}0.1835 & 0.2734 & 0.0623 & 0.1209 & 0.0664 & 0.0771 \\ 0.1835 & 0.2734 & 0.0623 & 0.1209 & 0.0664 & 0.0771 \\ 0.1835 & 0.2734 & 0.0623 & 0.1209 & 0.0664 & 0.0771 \\ 0.1835 & 0.2734 & 0.0623 & 0.1209 & 0.0664 & 0.0771 \\ 0.2447 & 0.1823 & 0.0415 & 0.0806 & 0.0442 & 0.0514 \\ 0.2447 & 0.1823 & 0.0415 & 0.0806 & 0.0442 & 0.0514 \\ 0.2447 & 0.1823 & 0.0415 & 0.0806 & 0.0442 & 0.0514 \\ 0.3059 & 0.0911 & 0.0208 & 0.0403 & 0.0221 & 0.0257 \\ 0.3059 & 0.0911 & 0.0208 & 0.0403 & 0.0221 & 0.0257 \\ 0.3059 & 0.0911 & 0.0208 & 0.0403 & 0.0221 & 0.0257 \\ 0.3059 & 0.0911 & 0.0208 & 0.0403 & 0.0221 & 0.0257 \\ 0.3059 & 0.0911 & 0.0208 & 0.0403 & 0.0221 & 0.0257\end{matrix} ]$$

The elements of this global system transition matrix are the probabilities of transitions among global system states. The elements of both the rows and columns are in the order of (1,1), (1,2), (1,3), (1,4), (2,1), (2,2), (2,3), (3,1), (3,2), (3,3), (3,4), (3,5). 1 . . . 12 are assigned as their corresponding global system state index. For example, the element w₍₁₂₎₍₇₎=w_{(3,5)(2,3)} is the transition probability from the sub-state 5 of phase 3 (global system state 12) to the sub-state 3 of phase 2 (global system state 7). Layer decomposability assures that w_{(3,5)(2,3)}=y₃₂u²_{G3}=0.5×0.6117=0:3059.

As the above equation does not depend on i anymore given a global system state (I, i), we can find that in the matrix W rows pertaining to a particular value I are constant.

At this point, we are able to compute a ranking for the global system states. There are two possible approaches.

Approach 1: We apply the standard PageRank algorithm to W to rank all states, i.e. we apply the method of maximal irreducibility to W before we launch the power method to compute the principal Eigenvector. We obtain πW as follows:

The first column in Table 2 above is the list of global system states with there index number on the left-hand side.

$$\begin{matrix}1 \text{:} ( 1 , 1 ) \\ 2 \text{:} ( 1 , 2 ) \\ 3 \text{:} ( 1 , 3 ) \\ 4 \text{:} ( 1 , 4 ) \\ 5 \text{:} ( 2 , 1 ) \\ 6 \text{:} ( 2 , 2 ) \\ 7 \text{:} ( 2 , 3 ) \\ 8 \text{:} ( 3 , 1 ) \\ 9 \text{:} ( 3 , 2 ) \\ 10 \text{:} ( 3 , 3 ) \\ 11 \text{:} ( 3 , 4 ) \\ 12 \text{:} ( 3 , 5 )\end{matrix} π w = ( \begin{matrix}0.0682 \\ 0.0547 \\ 0.0596 \\ 0.0499 \\ 0.0545 \\ 0.1073 \\ 0.2281 \\ 0.1562 \\ 0.0452 \\ 0.0760 \\ 0.0474 \\ 0.0530\end{matrix} ) \begin{matrix}5 \\ 7 \\ 6 \\ 10 \\ 8 \\ 3 \\ 1 \\ 2 \\ 12 \\ 4 \\ 11 \\ 9\end{matrix} \tilde{π} w = ( \begin{matrix}0.658 \\ 0.0498 \\ 0.0556 \\ 0.0442 \\ 0.0495 \\ 0.1118 \\ 0.2541 \\ 0.1683 \\ 0.0383 \\ 0.0744 \\ 0.0408 \\ 0.0474\end{matrix} ) \begin{matrix}5 \\ 7 \\ 6 \\ 10 \\ 8 \\ 3 \\ 1 \\ 2 \\ 12 \\ 4 \\ 11 \\ 9\end{matrix}$$

Ranking Results of Approach 1 & 2

The middle vector πW gives the rank values (PageRank values) we computed based on the transition matrix W, and the column neighbouring to the vector on the right-hand side gives the order numbers of the states ranked by their rank values.

Approach 2: On the other hand, as Y is already primitive, hence W is primitive as well. We can compute directly its stationary state distribution without applying the Google's maximal irreducibility method. The resulting ranking is shown by the right vector πW in FIG. 2. We can see, other than minor differences in the absolute values, the two results rank all system states in an identical order.

The results imply that, in the Layered Markov Model defined by Y, U¹, U² and U³, the top three (highly ranked) overall system states are number 7, 8 and 6, namely (2,3), (3,1) and (2,2).

As in both Approach 1 and Approach 2, we have to compute in advance the global transition matrix W in order to derive the ranking of the global system states, we consider these two as centralized approaches for computing the global system state ranking. The differences between them are summarized in the following table where Pri. stands for Primitivity and MI stands for the Maximal Irreducibility trick used in PageRank:

| Approach | Pri. of Y | Pri. of W | If MI for W |
|---|---|---|---|
| 1 | Yes or No | Yes or No | Yes |
| 2 | Yes | Yes | No |

Partition Theorem for Rank Computation

A natural question is now that given the PageRank ranking for all four matrices Y, U¹, U² and U³, is it possible to obtain the stationary distribution for the global system states without deriving a new matrix W and applying the PageRank algorithm to it ?

We introduce now such an algorithm step-by-step:

1. At the phase level, if Y is already primitive, we can compute its stationary distribution \tilde{π}Y without applying the maximal irreducibility method to Y before the power method is applied. The element for phase I in the distribution vector is denoted by \tilde{π}(I).

Certainly, we can also compute the slightly different \tilde{π}Y by applying the maximal irreducibility method to Y even if Y is already primitive. We will see later on why we don't make this choice.

2. At the sub-state level within phases, for each phase I, we compute its stationary distribution π_{G}^{I} by applying the PageRank algorithm to U^{I}. Remember this resulting vector is related to our introduced gatekeeper sub-state of each phase P_{I}. We denote the element for sub-state i in the distribution vector by π_{G}^{I}(i).

3. For each global system state (I, i), we assign it a value as follows:
\tilde{π}(I,i)=\tilde{π}Y(I)π_{G}^{I}(i) (7)

The assignments to all global system states form a state distribution π.

We call this the Layered Method of rank computation. The result of this computation has the following (expected) property.

THEOREM The resulting vector of the Layered Method of rank computation is a probability distribution.

Approach 3: The PageRank vector πY for Y is:
π_{Y}=(0.2315, 0.4015, 0.3670)^{T}

We can replace \tilde{π}_{Y}(I) in (7) with π_{Y}(I) and the result is still a probability distribution. The corresponding multiplication becomes:

Unsurprisingly, this value is different from π_{w}(2,3) that we have computed before.

Approach 4 (the Layered Method): The vector \tilde{π}_{Y} for Y is:
\tilde{π}_{Y}=(0.2154, 0.4154, 0.3692)^{T}

Thus:
\tilde{π}(2,3)=\tilde{π}_{y}(2)π_{G}²(3)=0.4154×0.6117 =0.2541

Notice that this value is equal to that of π_{w}(2,3) we have obtained previously.

We call Approach 3 and Approach 4 the decentralized approaches for computing the global system state ranking, as we do NOT have to compute in advance the global transition matrix W. Instead we compute the ranking for the phases (or Web sites for the case of Web document ranking), the individual rankings for the sub-states in each phase (or the individual Web document rankings for each Web site), which can be done in a parallel or decentralized fashion.

The differences between Approach 3 and 4 are summarized in the table below:

| Approach | Pri. of Y | If MI for W |
|---|---|---|
| 3 | Yes or No | Yes |
| 4 | Yes | No |

Now we want to show the equality of the values obtained from Approach 2 and Approach 4 in the example is not accidental.

COROLLARY . Approach 2 and Approach 4 (the Layered Method) are equivalent.

This corollary results from the following theorem.

THEOREM . Give LMM=(P, Y, v_{Y}, O, U, v_{U}) as a Layered Markov Model where Y is primitive. The following vectors are first computed: the stationary state distribution vector π_{Y} of Y, the PageRank vectors π_{G}^{I}, I∈[1,N_{P}]. A new matrix W and a new vector π are derived in the following fashion:

1. Both the size of W and the length of \tilde{π} are

$${N}_{P} = {\sum }_{I = 1}^{{N}_{P}} {n}_{I}$$

i.e., the total number of the global system states in the model LMM. Every element of W and every element of \tilde{π} correspond to a global system state (I,i) ordered by I∈[1,N_{P}] and i∈[1,N_{I}].

2. Every element of W is defined by w_{(I,i)(J,j)}=y_{IJ}π_{G}^{J}(j).

3. Every element of \tilde{π} is defined by \tilde{π}(I,i)=\tilde{π}_{y}(I)π_{G}^{I}(i).

Then W is also primitive and its stationary state distribution vector is exactly \tilde{π}.

PROOF. For a primitive matrix, we know its stationary state distribution vector is the principal Eigenvector of its transposed matrix. Lemma2 assures that W is primitive. Lemma1 says W is Markovian, thus the principal Eigenvalue of W is 1. Then it remains to show
W′\tilde{π}=\tilde{π}
which is equivalent to that, given (I, i),

$${\sum }_{J} {\sum }_{i} {w}_{( J , j ) ( I , i )} \tilde{π} ( J , j ) = \tilde{π} ( I , i ) \\ ⇔ {\sum }_{J} {\sum }_{j} {y}_{JI} {π}_{G}^{I} ( i ) {\tilde{π}}_{Y} ( J ) {π}_{G}^{J} ( j ) = {\tilde{π}}_{Y} ( I ) {π}_{G}^{I} ( i ) \\ ⇔ {π}_{G}^{I} ( i ) {\sum }_{J} {y}_{JI} {\tilde{π}}_{Y} ( J ) {\sum }_{J} {π}_{G}^{J} ( j ) = {\tilde{π}}_{Y} ( I ) {π}_{G}^{I} ( i ) \\ ⇔ {π}_{G}^{I} ( i ) {\sum }_{J} {y}_{JI} {\tilde{π}}_{Y} ( J ) = {\tilde{π}}_{Y} ( I ) {π}_{G}^{I} ( i ) \\ ⇔ {\sum }_{J} {y}_{JI} {\tilde{π}}_{Y} ( J ) = {\tilde{π}}_{Y} ( I )$$

The last equality is guaranteed by the fact that ry is the stationary state distribution vector of Y.

We call the above theorem 2 the Partition Theorem for Rank Computation as the rank computation for the global system states in a Layered Markov Model can be decomposed into several steps that can be performed in a decentralized or/and parallel fashion, if decomposability is assumed and the phase transition matrix is primitive. The computation proceeds as follows:
At the phase layer, computation of the stationary distribution for the phase transition matrix.
At the sub-state layer, computation of the PageRank for individual sub-state stationary distribution for the sub-state transition matrix.
The aggregation of those vectors where only O(Nₚ) multiplications are necessary. In contrast, previous methods require doing a large number of multiplications of two Nₚ×Nₚ matrices until the resulting vector converges.

Application to Web Information Retrieval

We now discuss how the theoretical results obtained can be applied in the context of Web Information Retrieval. We know that search engines take into consideration both query-based ranking (for example, distances between queries and documents based on the Vector Space Model) and link- structure-based ranking (typically PageRank in Google and HITS-derived algorithm in Teoma) when ordering search results. We focus on the second aspect.

Different Abstractions for the Web Graph

Previous research work focused on the page granularity of the Web, i.e., a graph where the vertices are Web pages and the edges are links among pages. We propose to model the Web graph at the granularity of Web site. We call the graph at the document level the DocGraph, and the graph at the Web site level the SiteGraph. We also use the notion of SiteLink to designate hyperlinks among Web sites and DocLink for those among Web documents.

Thus, the graph of Web documents G_{D}(V_{D},E_{D}) with N_{D} pages is a in a DocGraph. We assume its corresponding SiteGraph is G_{S}(V_{S},E_{S}) with NS Web sites in total, a vs∈VS is a Web site, an es∈Es is a SiteLink. We use the notations G_{D}(V_{D},E_{D}), v_{d}, e_{d} for a DocGraph. We also use the shorthand d and s to represent a Web document and a Web site respectively. Taking one page d, we denote its corresponding site as s=site(d) with nₛ=size(s) local Web documents in total. Vd(s)⊂VD is the set of all local Web pages of the particular Web site s. Ed(s)⊂ED is defined to be the set of those e_{d} whose both originating and destination documents are members of V_{d}(s). G_{d}^{s}=(V_{d}(s), E_{d}(s)) is defined to be the sub-graph restricted with the Web site s.

We call the ranking of Web sites the SiteRank for the SiteGraph and the ranking of Web documents the DocRank for the DocGraph. PageRank is an example of DocRank, but DocRank can be computed in a way other than PageRank, for example, as in our approach in a decentralized fashion. We also use the notions SiteRank(G_{S}) and DocRank(G_{D}) to refer to the SiteRank result of G_{S} and DocRank result of G_{D} respectively. When we are using the matrix representations \hat{M}_{S} of G_{S} and \hat{M}_{D} of G_{D}, we also use SiteRank (\hat{M}_{S}) and DocRank(\hat{M}_{D}) to denote the rankings.

The SiteGraph was studied in earlier work under the name of hostgraph for purposes other than rank computation. This provided several good arguments on why the abstraction at the site level is useful. However, it is worth noticing that our notion of SiteGraph allows for the derivation of a dynamic or virtual graph of Web sites when we use dynamic or virtual relationships among Web pages instead of the static Web links. For example, when we use statistical information on navigation obtained from Web client traces, which are normally very different from the static Web link structure, as the set of edges E, we obtain a Web client trace-based SiteGraph. Similarly, a DocGraph using client traces can be defined. Thus hostgraph is simply one special type of SiteGraphs which uses the static hyper links among Web pages to define the edges.

Layered Method for DocRank

Having the analytical results above, the DocRank for a given Web graph can be computed with the following steps:

1. Derive the global DocGraph G_{D}(V_{D},E_{D}) from the given Web graph. Typically, DocLinks are processed.

2. Derive the global SiteGraph G_{S}(V_{S},E_{S}) from the DocGraph. Nodes in the SiteGraph are the Web sites. Edges are grouped together according to Web sites.

The numbers of SiteLinks are counted.

3. For each Web site s, derive the subgraph Gₛ d, its matrix representation \hat{M}_{D}^{S}=\hat{M}(G_{D}^{S}) and compute its π_{D}(s)=DocRank(\hat{M}_{D}^{S}) using the classical PageRank algorithm. This step can be completely decentralized in a peer-to-peer search system.

4. For the global SiteGraph GS(VS,ES), we first derive a primitive transition matrix and then compute its principal Eigenvector. The primitivity of the transition probability matrix is required by Theorem 2. In practice, we compute \hat{M}ₛ=\hat{M}(Gₛ) which is primitive and its principal Eigenvector πₛ=(πₛ(s₁), . . . , πₛ(s_{N}_{ₛ}))′ as the SiteRank.

5. For i=I, . . . , Ns, we list the N_{D} DocRank vectors π_{D} (si) and create an aggregate vector from them:
π_{D}=(π_{D}(s₁), . . . , π_{D}(s_{N}_{ₛ})′)′

By applying the above theorem, we perform a weighted product to obtain the final global ranking for all documents in the DocGraph GD(V_{D},E_{D}):
DocRank(G_{D})=(πₛ(s₁)π_{D}(s₁)′, . . . , πₛ(s_{N}_{ₛ})π_{D}(s_{N}_{ₛ})′)′

Personalization of rankings can be easily implemented in our layered method for DocRank. Personalization at the lower layer, i.e., the layer of local Web documents within specific Web sites, can be realized in Step 3 by providing different personalized vectors in the function body of \hat{M}(G_{d}^{s}). Similarly, personalization at the higher layer, i.e., the layer of Web sites, can be realized in Step 4. Of course, personalization at both layers can be combined to use together.

An interesting and important advantage of the method of the invention is that spammers will find it difficult to spam a search engine using the ranking method of the invention, since they have to set up a large number of authoritative Websites to take advantage of the spamming links between sites.

The invention also concerns a ranking device, for example a server, a set of servers, an Internet appliance, etc for ranking linked items with one of the above method. This device may be organised to compute a local ranking of items in a Web site, in a domain, in the local area network of a company, or according to geographic, thematic criterion for example.

The authoritative rankings derived based on the above method are usually established in the context of a specific query, either in combination with other global ranking schemes or by pre- or post-processing query results.

1. A computerized method for ranking linked information items, comprising the steps of:
(1) generating a grouping of the items in accordance with a choosen grouping strategy;
(2) using the linking of the items and the grouping of the items for generating link among groups;
(3) generating a group score for each of the linked groups and, within each of the groups, generating an item score for each of the items within the group;
(4) using the group scores and the item scores in generating the ranking.

2. The method of claim 1, wherein said grouping strategy is based on an Internet domain name criterion.

3. The method of claim 1, wherein said grouping strategy is based on a personal preference criterion and/or on a geographic criterion.

4. The method of claims 1, wherein the links comprise at least one of a static hyperlink among Web items, a static reference among information items, and/or a quantified information about dynamic accessing trails among items.

5. The method of claim 1, wherein the information groups comprise at least one of:
a Web site of items, and/or
a library of items, and/or
a cluster of items, and/or
a group of items.

6. A computerized method for ranking linked information items, comprising the steps of:
(1) generating a grouping of the items in accordance with a choosen grouping strategy;
(2) determining links among groups;
(3) for at least some groups, computing a group ranking using only inter-group links,
(4) within at least several of the groups, computing a local item ranking for each items within the group,
(5) for at least some items, computing a global item ranking based on said group ranking and on said local item ranking.

7. The method of claim 6, the step of computing a local item ranking comprising:
computing a local external ranking of each item in a group, by weighting the number of links from other groups pointing to said item, using weigths depending on the group ranking of said other groups,
computing a local internal of each item in a group, taking into account links from items in said group only,
composing said local external ranking with said local internal ranking to compute said local item ranking.

8. The method of claim 7, wherein larger weights are given to said local external ranking than to said local internal ranking when computing said local item ranking.

9. The method of claim 7, wherein said step of computing a local item ranking is performed in a non iterative way by algebraic operations on said group ranking and on said local item ranking.

10. The method of claim 6, wherein said step of computing a local item ranking is performed locally in a distributed way.

11. The method of claim 10, wherein said step of computing a global item ranking based on said group ranking (Gs) and on said local item ranking (G^{s}_{d}) is performed without any knowledge of the global transition matrix.

12. The method of claim 6, wherein for each item said global item ranking (π(i,j)) is computed by multiplying the group ranking (π_{y}) of the group to which said item belongs with the local item ranking πⁱ_{G} of said item in said group.

13. The method of claim 12, wherein said step of computing a local item ranking is performed locally in a distributed way.

14. The method of claim 13, wherein said step of computing a local item ranking is performed locally in said group using information unavailable outside from said group.

15. The method of claim 14, wherein said information includes items, links to items or links from items unavailable outside from said group.

16. The method of claim 14, wherein said information includes Web user behaviour.

17. The method of claim 14, wherein said information is part of the hidden Web.

18. The method of claim 6, wherein said grouping strategy is based on an Internet domain name criterion.

19. The method of claim 6, wherein said grouping strategy is based on a personal preference criterion and/or on a geographic criterion.

20. The method of claims 6, wherein the links comprise at least one of a static hyperlink among Web items, a static reference among information items, and/or a quantified information about dynamic accessing trails among items.

21. The method of claim 6, wherein the information groups comprise at least one of:
a Web site of items, and/or
a library of items, and/or
a cluster of items, and/or
a group of items.

22. The method of claim 6, wherein different ranking algorithms are used for computing said local item rankings within different groups.

23. A computerized method used by a distributed Web search engine for computing a ranking score associated with a document, such as Web pages, in the Web, comprising the steps of:
(1) ranking at least some groups of documents using only inter-group links,
(2) within at least several of the groups, locally ranking at least some documents within the group,
(3) for at least one document, locally computing a global item ranking by multiplying said group ranking and said local document ranking

24. A ranking device for ranking linked items, said ranking depending on links between items, comprising:
means for retrieving a group ranking associated with several groups of items, wherein at least one group comprises more than one item,
means for ranking documents within at least one of said groups, in order to retrieve a local document ranking.
means for locally computing a global item ranking by composing said group ranking and said local document ranking.

25. The method of claim 24, said means for locally computing a global item comprising multiplying means for multiplying said group ranking and said local document ranking.

26. The ranking device of claim 24, being an Internet appliance.
